(19) United States
(12) Patent Application Publication
(10) Pub. No.: US 2015/0089595 A1
(43) Pub. Date: Mar. 26, 2015

(54) METHOD AND SYSTEM FOR FACILITATING ONLINE GAMING

(71) Applicants: Shun Yao, Davis, CA (US); Jess Port Telles, Davis, CA (US)

(72) Inventors: Jess Port Telles, Davis, CA (US); Shun Yao, Davis, CA (US)

(73) Assignees: Shun Yao, Davis, CA (US); Jess Port Telles, Davis, CA (US)

(21) Appl. No.: 14/109,776

(22) Filed: Dec. 17, 2013

Related U.S. Application Data
(60) Provisional application No. 61/881,907, filed on Sep. 24, 2013.

(51) Int. Cl. H04L 29/06; H04W 4/02

(52) U.S. Cl. CPC H04L 63/08; H04W 4/02
USPC 726/4

(57) ABSTRACT

One embodiment provides a system that facilitating location verification of a wireless access point and associated user devices. During operation, the access point establishes a secure communication channel with a location verification server. The access point then transmits to the location verification server an identifier of the access point, an external IP address of the access point, and location information for the access point via the secure communication channel. Next, the access point receives a packet from a user device, replaces the packet's source IP address with the access point's external IP address, and transmits the packet, thereby allowing the user device's physical location to be verified.

### RELATED APPLICATION

This application claims the benefit of U.S. Provisional Application No. 61/881,907, Attorney Docket Number TEYA13-1001PSP, entitled “METHOD AND SYSTEM FOR FACILITATING ONLINE GAMING,” by inventors Jess Port Telles and Shun Yao, filed 24 Sep. 2013.

### BACKGROUND

1. Field

This disclosure is generally related to online gaming. More specifically, this disclosure is related to a method and system for facilitating location verification for online gaming.

2. Related Art

An increasing number of states have passed or are in the process of passing laws that legalize online gambling and wagering. A critical building block in implementing a regulation-compliant online gaming system is a reliable mechanism for verifying a player's physical location and identity, because a majority, if not all, of the state laws that provide for online gaming require a player to be physically within the corresponding state and be older than the legal age to gamble.

A number of technologies are currently available for providing location information associated with a user's electronic device, such as smart mobile phone, personal digital assistant (PDA), tablet computer, laptop computer, and desktop computer. These technologies include global positional system (GPS), IP-based localization, and cellular signal multilateration (such as triangulation), and WiFi positioning. However, these technologies all have their shortcomings.

The GPS-based location verification technique relies on the GPS coordinates provided by a user's device to determine the user's location. Currently, however, there are many ready-to-use applications that a user can install to spoof his GPS coordinates. These applications can be sufficiently sophisticated to mimic a user's regular movements. Hence, location information that is solely derived from a user device's GPS data cannot be fully trusted.

IP-based localization technique relies on a user device's IP address to determine the location of that IP address. This determination process, however, is often unreliable and can have a large margin of error. Also, when a user is using a data services via a mobile phone (such as a 3G or 4G LTE enabled smart phone), the IP address is provided by a base station belonging to the wireless service carrier. The assigned IP address can only indicate the approximate location of the base station, whereas the user could be miles away from the base station. Another scenario where IP-based localization does not work very well is when a user is on an intranet behind a firewall. In this case, the external IP address of the firewall can only indicate the location of the firewall device, but not the user device behind the firewall. A further deficiency of IP-based localization is that IP addresses can be easily spoofed. For example, a user could use a proxy server to connect to an online gaming site, where the proxy server resides within the state that legalizes online gaming and the user resides out of that state.

Cellular signal multilateration (such as triangulation) relies on the cellular signals received by different base stations to determine the location of a user device. This technique is relatively more tamper proof because it uses information provided by the wireless service carriers. However, cellular signal triangulation is not always available, because a user might be in an area with poor signal quality. It can also be very costly for an online gaming provider to query a user's location from the wireless carrier on a regular basis. In addition, an online gaming provider will have to negotiate contracts to obtain such services with each wireless service carrier which can be costly and time-consuming. Furthermore, online gaming based on cellular-triangulation location verification is only limited to users of mobile phones. Users of computers, such as tablet PCs or laptops, would not be able to enjoy online gaming.

### SUMMARY

One embodiment provides a system that facilitating location verification of a wireless access point and associated user devices. During operation, the access point establishes a secure communication channel with a location verification server. The access point then transmits to the location verification server an identifier of the access point, an external IP address of the access point, and location information for the access point via the secure communication channel. Next, the access point receives a packet from a user device, replaces the packet's source IP address with the access point's external IP address, and transmits the packet, thereby allowing the user device's physical location to be verified.

In a variation of this embodiment, the system obtains the location information for the access point using a global positioning system (GPS) module.

In a variation of this embodiment, the location information includes a cellular phone number assigned to the access point, thereby allowing the location verification server to query a cellular service carrier to query the access point's location using the cellular phone number assigned to the access point.

One embodiment provides a system for facilitating location verification of a wireless access point and associate user devices. During operation, the system establishes a secure communication channel with a wireless access point. The system then receives location information for the access point via the secure communication channel. The system further maintains a mapping table, wherein an entry of the mapping table identifies a respective access point, an IP address of the access point, and location information of the access point, thereby facilitating verification of location of a device in communication with the access point.

In a variation of this embodiment, the entry of the mapping table includes an identifier of the access point, an external IP address of the access point, a set of location coordinates of the access point, and an expiration time.

In a variation of this embodiment, the system receives a query from a gaming server, wherein the query indicates an IP address associated with a user device. The system performs a look up of the mapping table based on the IP address associated with the user device and determines whether the IP address is located within a state based on the look up.

In a variation of this embodiment, the system receives a cellular phone number of the access point via the secure communication channel and obtains location information of the access point from a cellular service carrier based on the cellular phone number of the access point.

In a variation of this embodiment, the secure communication channel is a secure shell (SSH) tunnel.

In a variation of this embodiment, the entry of the mapping table further indicates an expiration time for the entry.

In a further variation, the system updates the expiration time in response to receiving location information for the access point.

### BRIEF DESCRIPTION OF THE FIGURES

FIG. 1 illustrates an exemplary architecture of a system that facilitates reliable location verification for online gaming, in accordance with one embodiment of the present invention.

FIG. 2 illustrates an exemplary WiFi access point, in accordance with an embodiment of the present invention.

FIG. 3 presents an exemplary mapping table that maps an access point to its location, in accordance with one embodiment of the present invention.

FIG. 4 presents a flow chart illustrating an exemplary process of an access point establishing communication with a location verification server and reporting its location, in accordance with one embodiment of the present invention.

FIG. 5 presents a flow chart illustrating an exemplary process of a location verification server establishing communication with an access point and receiving reports from the access point, in accordance with one embodiment of the present invention.

FIG. 6 presents a flow chart illustrating a process of a location verification server responding to a location verification request from a gaming server, in accordance with one embodiment of the present invention.

FIG. 7 presents a flow chart illustrating an exemplary process of a gaming server handling a user's gaming session request, in accordance with one embodiment of the present invention.

FIG. 8 illustrates an exemplary business operation platform in accordance with one embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

Embodiments of the present invention solve the problem of providing reliable, cost-effective, and scalable location verification for online gaming by deploying one or more WiFi hotspots at verifiable locations where players can log on and engage in online gambling and wagering. Such WiFi hotspots can be provided free of charge. Because each WiFi access point device can use one or more reliable and tamper-proof positioning technologies to provide its actual physical location, and because these hotspots have limited ranges (for example, a line-of-sight distance of 300 feet), the location of the covered area of a particular hotspot can be reliably verified. As a result, the location of any device that uses a given WiFi hotspot can be reliably verified, because the device is within this range from the WiFi hotspot.

In one embodiment, a third party hotspot provider can deploy a number of such hotspots at locations that are within the boundaries of a state that legalizes online gaming. The hotspot provider can then allow users to log on the WiFi network, and verify that any logged-on user is within a certain distance from the corresponding hotspot. As a result, the hotspot provider can verify that the location of a user that has successfully logged on is within the state boundaries.

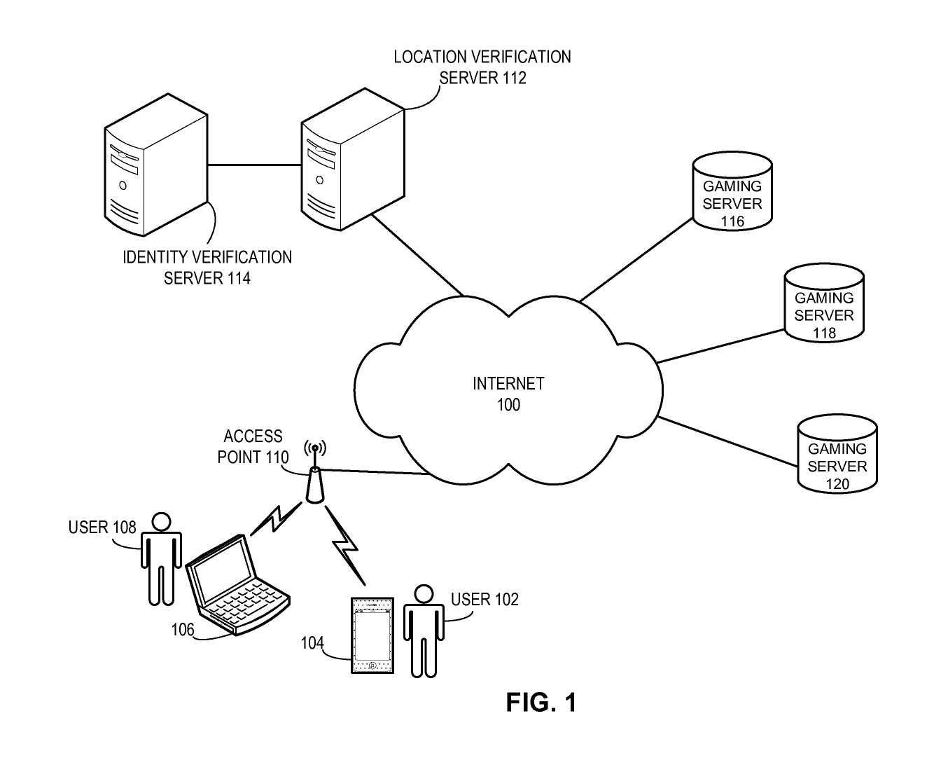

FIG. 1 illustrates an exemplary architecture of a system that facilitates reliable location verification for online gaming, in accordance with one embodiment of the present invention. In this example, one or more WiFi access points, such as access point 110, are coupled to Internet 100. Access point 110 is in communication with a location verification server 112. Also coupled to Internet 100 are gaming servers 116, 118, and 120. Location verification server 112 can optionally be coupled to a stand-alone identity verification server 114.

During operation, access point 110 is placed at an ascertainable location, which is within the boundaries of a state that legalizes online gaming. Access point 110 also has a limited range (for example, 100-300 yards). In one embodiment, the location of access point 110 is chosen in such a way that any device that is within the range of access point 110 can be guaranteed to be within the state boundary. For example, a smart phone 104 associated with user 102 can be logged on the WiFi network provided by access point 110. Similarly, a laptop or tablet computer 106 associated with a user 108 can be logged on the same WiFi network. Both devices 104 and 106 can be reliably verified to reside within the corresponding state.

In one embodiment, access point 110 can include a GPS module which is not accessible by any regular user and hence cannot be tampered with or spoofed. This GPS module can provide the coordinates of access point 110 at regular time intervals (such as every second, or other duration of time) to location verification server 112. This way, location verification server 112 can continuously (or at predetermined or configurable time intervals) monitor the physical location of access point 110 and hence the physical location of any device that is logged on to the WiFi network provided by access point 110. This location verification mechanism can ensure that the players' location is constantly checked. Hence, a user's compliance to the state's online-gaming regulation can be constantly verified.

Additionally, access point 110 can include other positioning mechanisms so that the location thereof can be determined based on a combination of different technologies. For example, access point 110 can include a cellular module which receives and transmits cellular signals within a cellular service carrier's network. The cellular service carrier can then perform cellular signal triangulation calculation based on the signals received at different cell towers or base stations, and locate access point 110 accordingly. Location verification server 112 can obtain this location information from the wireless carrier, and combine this information with the GPS data provided by access point 110 to determine the location of access point 110.

In one embodiment, when a device (take smart phone 104 for example) logs on to the WiFi network provided by access point 110, the device is assigned an IP address. This IP address can be an internal IP address, which is allocated by access point 110. The packets transmitted by smart phone 104 would have the assigned internal IP address as their source address. When these packets are processed and forwarded by access point 110, access point 110 can replace the internal IP address with an external IP address associated with access point 110 based on the network address translation (NAT) protocol.

Because location verification server 112 can regularly verify the location of access point 110, together with its access point 110's external IP address (which can be a static IP address provided by an Internet service provider (ISP)), location verification server 112 can maintain a mapping of access point 110's external IP address and its location information (such as GPS coordinates). When a gaming server receives packets with a source IP address of the external IP address of access point 110, the gaming server can regularly check with location verification server 112 to determine whether this IP address is located within the state boundary. As long as location verification server 112 continues to verify the location of access point 110 and such verified location information indicates a location within the state, location verification server 112 can verify with the gaming server that this IP address is located within the state.

Because the location of the access points are normally static, in one embodiment, a gaming server can cache the verified location information of each external IP address of an access point it has “seen” in the past, and hence obviate the need to verify the location with location verification server 112 each time it receives a packet with an access point's external IP address. A gaming server can periodically re-verify the location of its cached IP address with location verification server 112 by, for example, querying location verification server 112.

In a further embodiment, location verification server 112 can be coupled to an identity verification server 114 (or a third party identity verification service), which can verify the identity of a user. The user might be required to enter information that can be used to verify his age. Such information might include, but is not limited to, credit card information, social security number, driver's license number, address, telephone number, etc. In some embodiments, the user can be required to enter biometric information via his device, such as ocular information, retina scan, facial scan/photograph, and fingerprint. Additionally, the user can be required to submit such biometric information at predetermined or random time intervals, such that the user's identity can be verified on an on-going basis.

Note that location verification server 112 can facilitate location verification services based on each access point's IP address and physical location information (e.g., based on GPS coordinates and/or cellular signal triangulation). tThis service can be independent from any particular gaming provider. In other words, this location verification service is neutral to online casinos, or online gaming licensees (holders of online gaming licenses).

Note that location verification server 112 can include one or more processors, one or more memory devices, and a storage device (such as a hard drive). During operation, instructions stored in the storage device can be loaded into the memory device(s) and executed by the processor(s), thereby performing the various methods described herein.

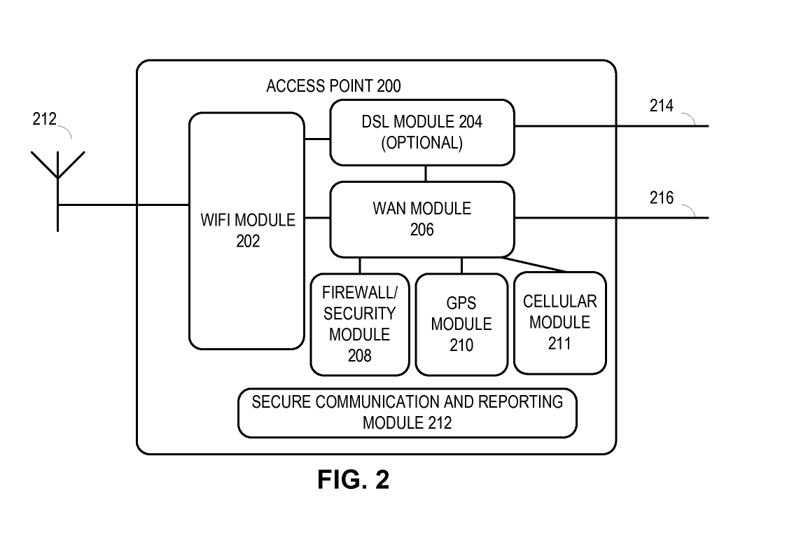

FIG. 2 illustrates an exemplary WiFi access point, in accordance with an embodiment of the present invention. In this example, an access point 200 includes a WiFi module 202, an optional DSL module 204, a wide area network (WAN) module 206, a firewall/security module 208, a GPS module 210, a cellular module 211, and a secure communication and reporting module 212. Also included with access point 200 are a WiFi transceiver 212, a phone port 214, and an Ethernet port 216. In one embodiment, access point 200 can provide the DSL modem function using DSL module 204. In this case, access point 200 can be plugged into a phone line via phone port 214. It is assumed that the DSL broadband Internet service is provisioned by the telephone/Internet service provider. As a result, DLS module 204 can provide connectivity (and a corresponding external IP address) to the Internet.

In a further embodiment, assume that Internet connectivity is provided by an external device (for example, a cable modem or a stand-alone DSL modem). In this case, WAN module 206 can be coupled to the external device via Ethernet port 216, and obtain an external IP address therefrom.

Note that in either case, DLS module 204 or WAN module 206 is responsible for performing NAT address translation for user packets. In such translation, a user packet's source IP address (which is an internal IP address) is replaced by access point 200's external IP address.

Firewall/security module 208 can provide filtering based on various fields in the packet headers, such as IP addresses, transport layer fields (TCP or UDP ports), and fields associated with upper layers.

GPS module 210 is a tamper-proof module that can continuously generate GPS coordinates for access point 200. In one embodiment, GPS module 210 transmits the GPS coordinates to location verification server 112 at regular time intervals. In a further embodiment, GPS module 210 can establish a secure tunnel (such as a secure shell (SSH) tunnel) to location verification server 112 for transmitting the GPS coordinates, which can ensure that the transmitted GPS data can also be tamper proof.

Cellular module 211 is responsible for transmitting and receiving cellular signals associated with a cellular wireless carrier/service provider (for example, AT&T, Verizon, Sprint, or T-Mobile). In one embodiment, cellular module 211 and provide a cellular-based data service as a backup for the regular Internet service (e.g., DLS or external connectivity via a cable modem). Cellular module 211 also facilitates cellular signal triangulation via the cellular service provider, which can use the signal transmitted by cellular module 211 to determine the location of access point 200. This location information can in turn be provided to location verification server 112 as additional verification, in addition to the GPS coordinates, of access point 200's location.

WiFi module 202 is responsible for providing the WiFi network within the specified transmission range. In one embodiment, WiFi module 202 includes a dynamic host configuration protocol (DHCP) function which can automatically allocate internal IP address to any device logged on the WiFi network.

In further embodiments, a user device might be required to provide a set of user credentials (such as a user name and a password) to log on the WiFi network. Such credentials can be provisioned to a user after the user has signed up with information which can be used to verify his identity.

Secure communication and reporting module 212 is responsible for establishing a secure communication channel (such as an SSH tunnel) with the location verification server and access point 200's location information as well as its identifier and external IP address.

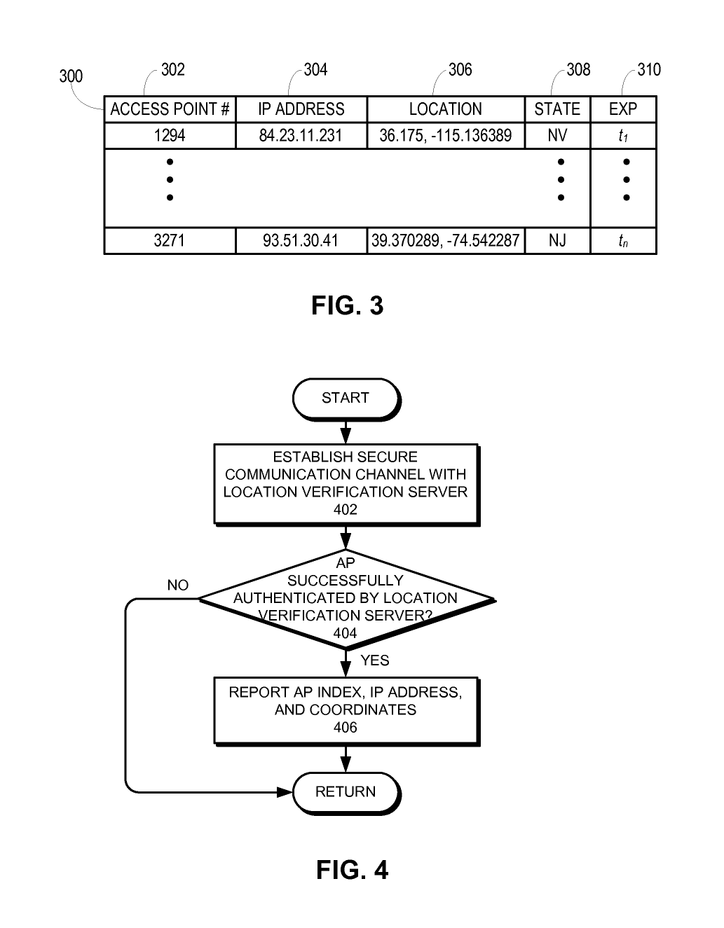

FIG. 3 presents an exemplary mapping table that maps an access point to its location, in accordance with one embodiment of the present invention. In this example, a location verification server can maintain a mapping table 300, which includes an access point index column 302, an IP address column 304, a location column 306, a state column 308, and an expiration time column 310.

Access point index column 302 stores the index or identifier of a particular access point. In one embodiment, this information can be further used to identify the make and model of a particular access point (for example, when it is used as a key to search a make/model table).

IP address column 304 stores the external IP address of a particular access point. This IP address can be an IPv4 address, and IPv6 address, or both. In addition, this IP address can be a static IP address provisioned by an ISP, or a dynamic IP address, depending on the service plan used by the access point.

Location column 306 stores the longitude and latitude coordinates of a particular access point. In one embodiment, these coordinates are or are derived from the GPS coordinates submitted by the access points and/or the coordinates provided by the cellular service provider based on cellular signal multilateration.

State column 308 stores the state location of a particular access point. In one embodiment, the location verification server can determine the state in which an access point resides based on the corresponding longitude and latitude coordinates.

Expiration time column 310 stores the expiration time for each entry in mapping table 300. In one embodiment, each entry, after it is updated, remains valid for a predetermined period of time. The value in expiration time column 310 indicates the time at which the corresponding entry expires. The expiration time value in a respective entry is updated when the location verification server receives a location update from the corresponding access point.

FIG. 4 presents a flow chart illustrating an exemplary process of an access point establishing communication with a location verification server and reporting its location, in accordance with one embodiment of the present invention. During operation, an access point first establishes a secure communication channel with a location verification server (e.g., via a Secure Shell (SSH) tunnel) (operation 402). Note that the access point may establish such a secure channel using a pre-configured security credential, which is also registered at the location verification server. Subsequently, the system determines whether the access point has been successfully authenticated by the location verification server (operation 404). If the authentication is not successful, the system returns to the default operation mode. If the authentication is successful, the access point then reports its index (which is an identifier to identify the access point with the location verification server), external IP address, and geographical location (e.g., GPS coordinates) to the location verification server (operation 406).

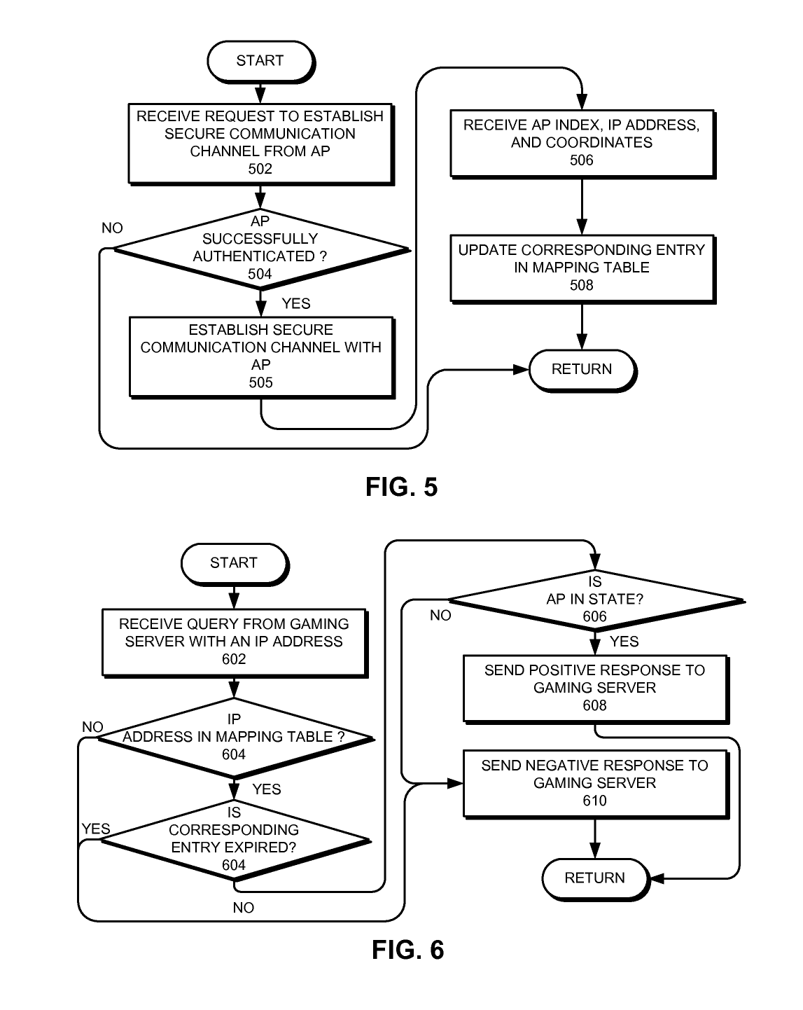

FIG. 5 presents a flow chart illustrating an exemplary process of a location verification server establishing communication with an access point and receiving reports from the access point, in accordance with one embodiment of the present invention. During operation, a location verification server receives from an access point a request to establish a secure communication channel (such as an SSH tunnel), and authenticates the access point based on its credentials (operation 502). The location verification server than determines whether the access point is authenticated successfully (operation 504). If the authentication is not successful, the location verification server returns to its normal operation mode without establish the secure communication channel with the access point. If the authentication is successful, the location verification server establishes the secure communication channel with the access point (operation 505). Subsequently, the location verification server receives from the access point via the secure communication channel the access point's index, its IP address, and GPS coordinates (operation 506). If the system uses cellular signal multilateration for location verification, the location verification server can receive a cellular phone number from the access point, and query a cellular service carrier with the phone number to obtain the access point's location coordinates. The location verification server then updates the corresponding entry in its mapping table (such as mapping table 300 in FIG. 3) based on the access point's location coordinates.

FIG. 6 presents a flow chart illustrating a process of a location verification server responding to a location verification request from a gaming server, in accordance with one embodiment of the present invention. During operation, a location verification server receives a query from a gaming server, wherein the query includes an IP address (operation 602). Note that this query is sent by the gaming server in order to verify the location of the IP address, which can be the source IP address of a packet sent from a user's device, when the user wishes to start a new gaming session with the gaming server. In one embodiment, this IP address is the external IP address of the access point through which the user's device is in communication with the Internet.

Next, the location verification server determines whether the IP address in the query is in its local mapping table (e.g., mapping table 300) (operation 604). If not, the location verification server sends a negative response to the gaming server indicating that the queried IP address does not appear to be located in the state (operation 610). Otherwise, the location verification server further determines whether the corresponding entry in the mapping table is expired (operation 604). If the entry is expired, the system sends a negative response to the gaming server (operation 610). If the entry is not expired, the system then determines whether the access point associated with the queried IP address is located in the state (operation 606). If the IP address does not belong to any access point in the state, the system sends a negative response to the gaming server (operation 610). If the access point is in the state, the system then sends positive response to the gaming server (operation 608). Otherwise, if the access point is not located in the state, the system sends a negative response to the gaming server (operation 610).

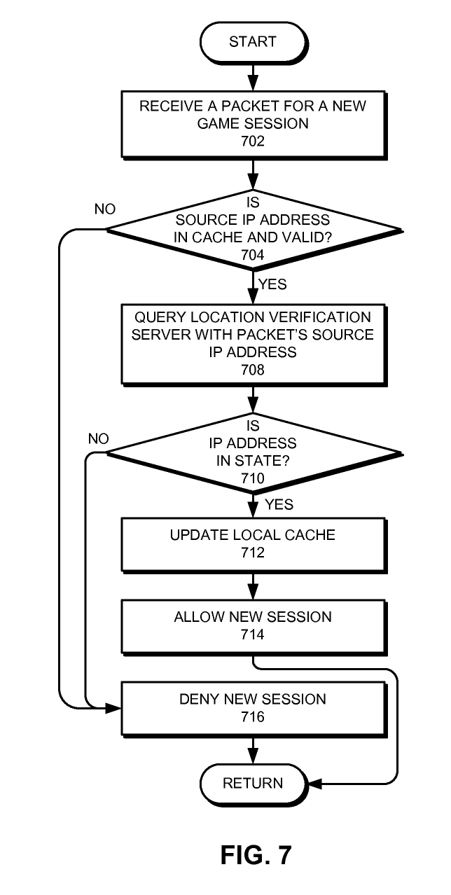

FIG. 7 presents a flow chart illustrating an exemplary process of a gaming server handling a user's gaming session request, in accordance with one embodiment of the present invention. During operation, a gaming server receives a packet from a user device (such as a smart phone or tablet computer) for a new game session (operation 702). The gaming server then checks whether the source IP address (which can be the external IP address of an access point) of the received packet is in its local cache (which caches the location information of verified IP addresses) and, if so, if the entry in the cache is still valid (operation 704). If not, the gaming server denies the user's request for a new session (operation 716). Otherwise, the gaming server queries the location verification server with the user packet's source IP address (operation 708). Next, the gaming server determines whether the user device's IP address (which can be the access point's IP address) is located within the state (operation 710). If so, the gaming server updates its local cache (operation 712) and allows the new user gaming session (714). Otherwise, the gaming server denies the new session (operation 716).

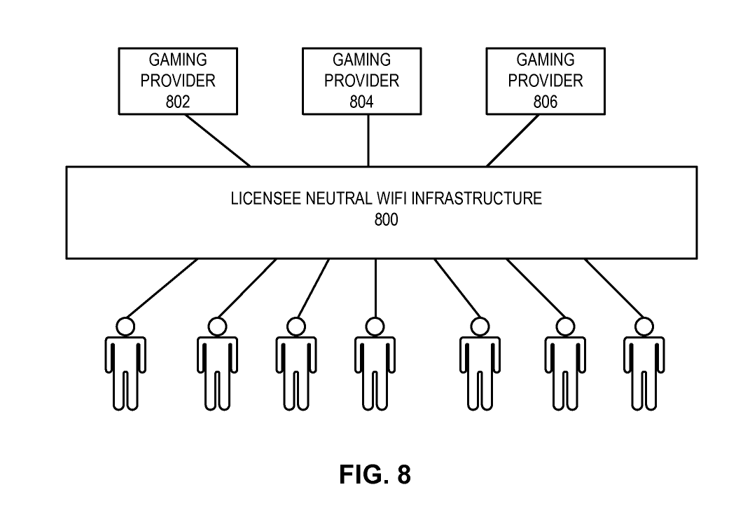

FIG. 8 illustrates an exemplary business operation platform in accordance with one embodiment of the present invention. As mentioned above, the access points and location verification server can function jointly as a licensee neutral WiFi infrastructure 800 to support online gaming with reliable location verification. Multiple users can use WiFi infrastructure 800 with verifiable location information to enjoy online gaming provided by a number of gaming providers 802, 804, and 806.

In one embodiment, the aforementioned access points can be placed in public places such as bars, restaurants, coffee shops, hotels, malls, movie theaters, etc. Users who are logged on to the WiFi at these locations can be reliably verified to be within the state where online gaming is legal.

In a further embodiment, the aforementioned access points can be provided to individual users, and be placed at their location of choice. In this case, the user can create a local WiFi network where he can use any wireless device to enjoy online gaming.

The data structures and code described in this detailed description are typically stored on a computer-readable storage medium, which may be any device or medium that can store code and/or data for use by a computer system.

The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer executed method for facilitating location verification of a wireless access point and associated user devices, comprising:
establishing a secure communication channel with a location verification server;
transmitting to the location verification server an identifier of the access point, an external IP address of the access point, and location information for the access point via the secure communication channel;
receiving a packet from a user device;
replacing the packet's source IP address with the access point's external IP address; and
transmitting the packet, thereby allowing the user device's physical location to be verified.

2. The method of claim 1, further comprising obtaining the location information for the access point using a global positioning system (GPS) module.

3. The method of claim 1, wherein the location information includes a cellular phone number assigned to the access point, thereby allowing the location verification server to query a cellular service carrier to query the access point's location using the cellular phone number assigned to the access point.

4. A computer executed method for facilitating location verification of a wireless access point and associate user devices, the method comprising:
establishing a secure communication channel with a wireless access point;
receiving location information for the access point via the secure communication channel; and
maintaining a mapping table, wherein an entry of the mapping table identifies a respective access point, an IP address of the access point, and location information of the access point, thereby facilitating verification of location of a device in communication with the access point.

5. The method of claim 4, wherein the entry of the mapping table includes:
an identifier of the access point;
an external IP address of the access point;
a set of location coordinates of the access point; and
an expiration time.

6. The method of claim 4, further comprising:
receiving a query from a gaming server, wherein the query indicates an IP address associated with a user device;
performing a look up of the mapping table based on the IP address associated with the user device; and
determine whether the IP address is located within a state based on the look up.

7. The method of claim 4, further comprising:
receiving a cellular phone number of the access point via the secure communication channel; and
obtaining location information of the access point from a cellular service carrier based on the cellular phone number of the access point.

8. The method of claim 4, wherein the secure communication channel is a secure shell (SSH) tunnel.

9. The method of claim 4, wherein the entry of the mapping table further indicates an expiration time for the entry.

10. The method of claim 9, further comprising updating the expiration time in response to receiving location information for the access point.

11. A wireless access point for facilitating location verification of associated user devices, comprising:
a secure communication module operable to establish a secure communication channel with a location verification server;
a reporting module operable to transmit to the location verification server an identifier of the access point, an external IP address of the access point, and location information for the access point via the secure communication channel;
a receiver operable to receive a packet from a user device;
an address translation module operable to replace the packet's source IP address with the access point's external IP address; and
a transmitter operable to transmit the packet, thereby allowing the user device's physical location to be verified.

12. The wireless access point of claim 11, further comprising a location information module operable to obtain the location information for the access point using a global positioning system (GPS) module.

13. The wireless access point of claim 11, wherein the location information includes a cellular phone number assigned to the access point, thereby allowing the location verification server to query a cellular service carrier to query the access point's location using the cellular phone number assigned to the access point.

14. A computer system for facilitating location verification of a wireless access point and associate user devices, the computer system comprising:
a processor; and
a memory storing instructions which when executed by the process cause the processor to:
establish a secure communication channel with a wireless access point;
receive location information for the access point via the secure communication channel; and
maintain a mapping table, wherein an entry of the mapping table identifies a respective access point, an IP address of the access point, and location information of the access point, thereby facilitating verification of location of a device in communication with the access point.

15. The computer system of claim 14, wherein the entry of the mapping table include:
an identifier of the access point;
an external IP address of the access point;
a set of location coordinates of the access point; and
an expiration time.

16. The computer system of claim 14, further comprising:
a receiving module receiving a query from a gaming server, wherein the query indicates an IP address associated with a user device;
a look-up module operable to perform a look up of the mapping table based on the IP address associated with the user device; and
a determination module operable to determine whether the IP address is located within a state based on the look up.

17. The computer system of claim 14, further comprising:
a receiving module operable to receive a cellular phone number of the access point via the secure communication channel; and
a location information module operable to obtain location information of the access point from a cellular service carrier based on the cellular phone number of the access point.

18. The computer system of claim 14, wherein the secure communication channel is a secure shell (SSH) tunnel.

19. The computer system of claim 14, wherein the entry of the mapping table further indicates an expiration time for the entry.

20. The computer system of claim 19, wherein the expiration time is updated in response to receiving location information for the access point.
